(19) United States
(12) Patent Application Publication
(10) Pub. No.: US 2024/0177020 A1
(43) Pub. Date: May 30, 2024

(54) METHOD FOR DYNAMICALLY RECOMMENDING FORECAST ADJUSTMENTS THAT COLLECTIVELY OPTIMIZE OBJECTIVE FACTOR USING AUTOMATED ML SYSTEMS

(71) Applicant: SAMYA.AI INC, Nothbrook, IL (US)

(72) Inventors: Deepinder Singh DHINGRA, Bangalore (IN); Ankur VERMA, Bangalore (IN); Yadunath GUPTA, Bangalore (IN); Siddharth SHAHI,, Bangalore (IN); Rajat SRIVASTAVA, Bangalore (IN); Rohit KUMAR, Jalahalli East (IN)

(21) Appl. No.: 17/837,010

(22) PCT Filed: Jun. 30, 2021
(86) PCT No.: PCT/US2021/039999

§ 371 Date: Jun. 9, 2022

(30) Foreign Application Priority Data
Jun. 30, 2020 (IN) 202041027873

(51) Int. Cl. G06N 5/022

(52) U.S. Cl. CPC G06N 5/022

(57) ABSTRACT

A method for integrating a machine learning (ML) model that impacts different factor groups for generating a dynamic recommendation to collectively optimize an objective factor is provided. The method includes (i) obtaining external and historical data associated with use-case including historical data of a forecasted, objective factor and historical data of at least one factor group associated with the use-case, (ii) generating a probabilistic forecasting model for forecasted factor, (iii) generating a relationship model based on a relationship between the forecasted factor, model of objective factor and one or more factors, (iv) determining an optimization model based on the probabilistic forecasting model and the relationship model by at least one adjustment of the existing forecast of the forecasted factor, (v) dynamically generating a recommendation to adjust an existing forecast based on the optimization function, and (vi) applying the recommendation at the use-case to collectively optimize objective factor.

### RELATED APPLICATIONS

This application is a Continuation Application of PCT/US2021/039999, filed Jun. 30, 2021, which claims priority benefit of Indian Patent Application No. 202041027873, filed Jun. 30, 2020, which are incorporated entirely by reference herein for all purposes.

### FIELD

The embodiments herein generally relate to dynamically recommending adjustments in a forecast of a use-case, and more particularly, using automated systems of machine learning models to generate dynamic recommendations of forecast adjustments that collectively optimize an objective factor of the use-case.

### BACKGROUND ART

Organizations relating to the use-case of consumer goods have complex operations. One or more teams participate in one or more activities that impact factor groups associated with a team.

Traditional approaches for sales and distribution, promotion, and inventory optimization have been done separately. As teams optimize for different areas and factor groups affecting these areas, the organization as a whole has complex operations due to multiple channels, products, customer segments and geographically distributed system operations that span across countries. The effective impact of the teams gets limited and they are not able to collectively optimize an individual objective factor of the organization. Also, the traditional systems for enterprise resource planning are not architected to handle high volume, change, and speed scenarios that have complex relationships. There are systems which use different types of probability forecasting. Organizations are usually faced with a decision on whether and by how much to adjust a forecast based on the latest run of the forecast that might include new information both on the latest actuals of the metrics/objective factor or new information about factor groups and such decisions impact many activities on the supply side and demand side. The current probability forecasting is not accurate and may not add enough value as these systems miss the mark by significant margin. Also, different business objectives have specific constraints at different tiles which are not accounted for. These traditional systems are also not architected to learn from the latest patterns and signals from different information sources. Also, the human factor is not taken into account in many of these existing systems, resulting off the mark forecasting which leads to compounding business problems. Also, these systems do not work with dynamic data and changes in objective factors from multiple sources. Further, the number increase of factors, combination of units such as products, channels or geographies amount to the sheer scale, complexity and volatility of the operations and the organization is unable to accurately anticipate demand in the future for different products in a holistic manner and are unable to collectively optimize an objective factor of the organization. The inefficiencies from this inability to collectively optimize are passed on to the respective departments. For example, an inventory department becomes unable to accurately carry the right inventory at the right location and is unable to adapt to changing demand, or a promotions department becomes unable to optimize and quantify the impact of price reductions and promotions, and a sales & distribution department becomes unable to carry out focused sales and distribution activities on which channels, locations, and customer segments it should focus on.

This inability of collective optimization leads to various negative consequences related to the objective factor of the organization such as inventory imbalance, low return of investment from promotion, low effectiveness for pricing, and inefficient sales & distribution activities. The overall impact of the negative consequences on the organizations is much severe as it leads to revenue leakage and loss of revenue growth potential.

Accordingly, there remains a need for an integrated system that can dynamically recommend forecast adjustments that collectively optimize an objective factor of the use-case using automated ML systems.

### SUMMARY

In view of the foregoing, embodiments herein provide a method for dynamically recommending forecast adjustments that collectively optimize an objective factor using automated ML systems. The method comprising includes (i) obtaining external data and a historical data associated with a use-case, wherein the historical data includes historical data of a forecasted factor, historical data of an objective factor and historical data of at least one factor group associated with the use-case, (ii) generating a probabilistic forecasting model for a forecasted factor of the use-case using the first automated system of machine learning models that generates different probabilistic forecasts of the forecasted factor with respect to different values of a factor, (iii) generating a relationship model based on a relationship between the forecasted factor, a model of an objective factor and one or more factors using a second automated system of machine learning models, (iv), determining an optimization model based on the probabilistic forecasting model and the relationship model by at least one adjustment of the existing forecast of the forecasted factor using a third automated system of machine learning models, wherein said at least one adjustment includes an amount of return gained on said adjustment and an amount of risk undertaken in said adjustment, (v) dynamically generating a recommendation to adjust an existing forecast that collectively optimizes the objective factor based on the optimization function using the third automated system of machine learning models, and (vi) dynamically applying the recommendation at the use-case to collectively optimize the objective factor.

In some embodiments, the method further comprises automatically causing a comparison of the probabilistic forecast with an existing forecast of the forecasted factor, wherein the existing forecast of the forecasted factor is generated by at least one of an automated system and a cognitive system.

In some embodiments, the method includes (i) training at a server the first automated system of machine learning models that includes one or more machine learning models using the historical data of a forecasted factor and the historical and planned values of at least one factor of a factor group associated with the use-case, (ii) training at a server the second automated system of machine learning models that includes one or more machine learning models using the external data, the historical data of a forecasted factor, historical and planned values of an objective factor and the historical data of at least one factor group associated with the use-case, (iii) training at a server the third automated system of machine learning models that includes one or more machine learning models using the training data and output of both the first automated system of machine learning models and the second automated system of machine learning models.

In some embodiments, the method further comprises using at least one machine learning model to estimate the optimization function.

In some embodiments, generating the probabilistic forecast for the forecasted factor of the use-case further comprises (a) determining a probability distribution of at least one forecast values of the forecasted factor associated with a set, wherein the set includes a product and a distribution location of the product, (b) automatically selecting a prediction interval of the forecast for at least one probability level, and (c) determining a probability of the probability distribution falling in the prediction interval to obtain the probabilistic forecast.

In some embodiments, the objective factor includes a service level, and an out of stock and the objective factor is associated with at least one constraint that includes an inventory holding cost, and an inventory

In some embodiments, at least one machine learning model of the first automated system of machine learning models utilize deep learning, probabilistic machine learning and advanced statistical methods.

In some embodiments, at least one machine learning model of the third automated system of machine learning models utilizes stochastic optimization and/or reinforcement learning

In some embodiments, the method further comprises tracking at least one adjustment made in the use-case based on the recommendation to enable feedback based learning of at least one machine learning model of at least one of the first automated system of machine learning models, the second automated system of machine learning models and the third automated system of machine learning models to provide an improved recommendation.

In some embodiments, a system of dynamically generating recommendations to adjust an existing forecast that collectively optimizes an objective factor using an automated system of machine learning models, the system comprising (i) a probabilistic forecast management server that comprises (a) a memory that stores a set of instructions, and (b) a processor that executes the set of instructions and is configured to (I) obtaining training data comprising external data and internal data associated with at least one factor group of a use-case, wherein the internal data includes historical data of a forecasted factor, historical data of an objective factor and historical and planned values of at least one factor of a factor group associated with the use-case, (II) generating a probabilistic forecasting model for a forecasted factor of the use-case using the first automated system of machine learning models that generates different probabilistic forecasts of the forecasted factor with respect to different values of a factor, (III) generating a relationship model based on a relationship between the forecasted factor, an objective factor and at least one factor using a second automated system of machine learning models, wherein the at least one factors is a constraint factor, (IV) determining an optimization model using a simulation based optimization, wherein the simulation is run on at least one adjustment of the existing forecast of the forecasted factor based on the probabilistic forecasting model and the relationship model using a third automated system of machine learning models, wherein said at least one adjustment includes an amount of return gained on said adjustment and an amount of risk undertaken in said adjustment, (V) dynamically generating a recommendation to adjust an existing forecast that collectively optimizes the objective factor based on the optimization model using the third automated system of machine learning models, and (VI) dynamically applying the recommendation at the use-case to collectively optimize the objective factor.

### BRIEF DESCRIPTION OF THE DRAWINGS

The embodiments herein will be better understood from the following detailed description with reference to the drawings, in which:

FIG. 1 is a block diagram that illustrates a system of dynamically recommending forecast adjustments that collectively optimize an objective factor using automated ML systems according to some embodiments herein;

FIG. 2 is a block diagram of the probabilistic forecast management platform of a probabilistic forecast management server of FIG. 1 according to some embodiments herein;

FIG. 3 is a block diagram of the probabilistic forecast management environment of the probabilistic forecast management server of FIG. 1 according to some embodiments herein;

FIG. 4 is a block diagram of a repository of the probabilistic forecast management platform FIG. 2 according to some embodiments herein;

FIG. 5 is a block diagram of simulation based learning to obtain an optimization model, according to some embodiments herein;

FIG. 6 is a block diagram of a feedback loop which enables reinforcement learning of at least one machine learning model to provide an improved recommendation according to some embodiments herein;

FIG. 7 is an exemplary graphical representation of probabilistic demand forecasted factor according to an embodiment herein;

FIG. 8 is an exemplary graphical representation of adjustment recommendation for an objective factor, according to an embodiment herein;

FIG. 9 is a flow diagram that illustrates a method of dynamically recommending forecast adjustments that collectively optimize an objective factor using automated ML systems according to some embodiments herein; and

FIG. 10 is a block diagram of a device used in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

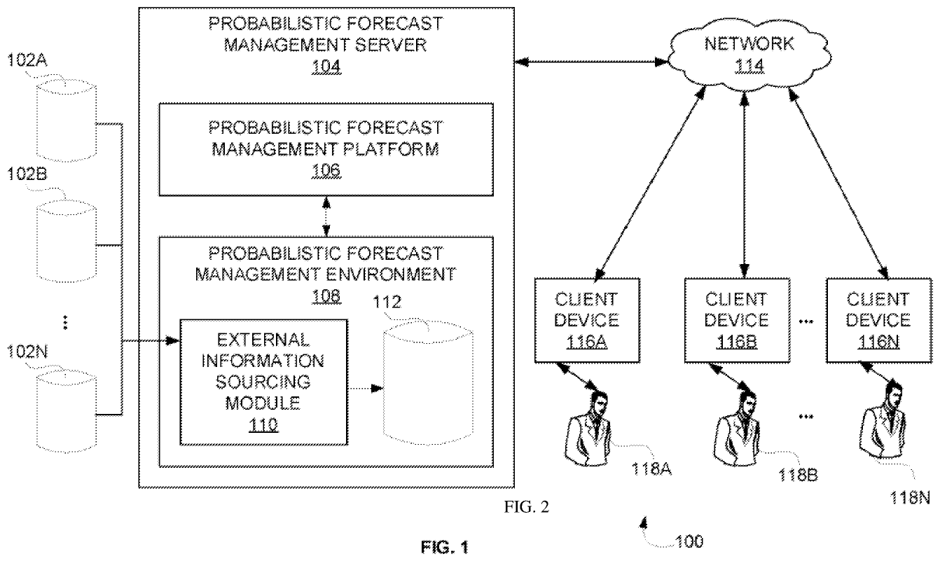

Referring now to the drawings, and more particularly to FIGS. 1 through 10, where similar reference characters denote corresponding features in a consistent manner throughout the figures, there are shown preferred embodiments. A “use-case” in this specification is defined as an organization or enterprise that uses a probabilistic forecast management service.

FIG. 1 is a block diagram 100 that illustrates a system of dynamically recommending forecast adjustments that collectively optimizes an objective factor using automated ML systems according to some embodiments herein. The block diagram 100 includes one or more external data sources 102A-N, a probabilistic forecast management server 104, a network 114, and one or more client devices 116A-N associated with one or more clients 118A-N. The probabilistic forecast management server 104 includes a probabilistic forecast management platform 106 and a probabilistic forecast management environment 108 that includes an external information-sourcing module 110 and an external information database 112. In some embodiments, the probabilistic forecast management server 104 includes probabilistic forecast management resources residing within the probabilistic forecast management environment 108. In some embodiments, the probabilistic forecast management platform 106 manages the probabilistic forecast management resources to provide probabilistic forecast management as a probabilistic forecast management service to the one or more client devices 116A-N through the network 114. In some embodiments, the network 114 is a wired system. In some embodiments, the network 114 is a wireless system. In some embodiments, the network 114 is a combination of a wired system and a wireless system. In some embodiments, the network 114 is the Internet.

In some embodiments, the one or more client devices 116A-N and the probabilistic forecast management service are associated with a use-case. In some embodiments, the one or more client devices 116A-N, without limitation, may be selected from a mobile phone, a Personal Digital Assistant (PDA), a tablet, a desktop computer, or a laptop. In some embodiments, the use-case is an organization that is related to consumer goods, e.g., foods, drinks, clothes, etc. In some embodiments, the one or more client devices 116A-N are used in combination with the probabilistic forecast management platform 106 to specify a meta-data model of the use-case with which the client device 116 is associated. One or more factor groups external to the use-case and one or more internal factor groups to the enterprise operation may be identified. In some embodiments, historical data and planned data associated with the one or more internal factor groups may be obtained at the probabilistic forecast management server 104 from the client device 116A-N using the network 114.

In some embodiments, the external information sourcing module 110 associated with the probabilistic forecast management server 104 obtains external data from the one or more external data sources 102A-N. The external data sources 102A-N may include a weather data source, macro-economic data source, an industry indices data source that includes indices such as Gross Domestic Product (GDP), an inflation metric or employment rate, etc., commodities data source, market trends data source, consumer sentiments data source and a demographic data source. In some embodiments, the demographic data source includes income data of residents, population, etc. The external information-sourcing module 110 processes the data obtained from the external data sources 102A-N and stores in the external information database 112. In some embodiments, the external information database 112 includes information which remains horizontal for one or more probabilistic forecast management services. In some embodiment, the probabilistic forecast management server 104 may obtain weather information to compute the demand for the product from one or more weather sensors. The probabilistic forecast management server 104 integrates a one or more machine-learning models that impact an internal factor group from the one or more internal factor groups for generating a dynamic recommendation of adjusting an existing forecast to collectively optimize an objective factor. In some embodiments, the internal factor group includes a pricing and promotions factor group, a sales and distribution factor group, or an inventory placement and allocation factor group. In some embodiments, the pricing and promotions factor group includes at least one of a location, a store, a product, a price-pack, a placement of product, a placement, a range, a visibility, a coverage, a frequency, a distribution reach, a channel, an event type or an inventive. In some embodiments, the sales and distribution factor group includes at least one of a channel, a location of a promotion activity, a product for promotion, a price-pack, a time period or a calendar for a promotion activity, a promotion type, a price for a promotion activity, a discount for a promotion activity, or a creative for a promotion activity.

In some embodiments, the inventory placement and allocation factor group includes at least one of a location of inventory, a store of inventory, a type of inventory, a source location of inventory, a transfer of inventory, a new quantity for the inventory, a safety stock of inventory for a product, on hand levels of inventory or a reorder quantity of inventory, or an allocation quantity of inventory.

The probabilistic forecast management server 104 processes a specification information of the probabilistic forecast management service and internal data that is associated to one or more factor groups. Internal data may refer to the data that is internal to a use-case and may also include a combination of historical and planned data associated with a one or more factor groups. In some embodiments, the factor group may include but not limited to a pricing and promotions factor group, a sales and distribution factor group or an inventory factor group.

The internal data may be associated with a factor group of the use-case. In some embodiments, the specification information includes internal data of the use-case and a meta-data model that corresponds to the use-case. In some embodiments, the one or more client devices 116A-N specify the specification information of the use-case for which the probabilistic forecast management service is created. In some embodiments, the one or more client devices 116A-N specify the meta-data model and the internal data corresponds to the use-case. In some embodiments, the internal data corresponds to the one or more internal factor groups. In some embodiments, the pricing and promotions factor group may include factors such as a promotion, at least one sales activity, at least one distribution activity history, and at least one plan. In some embodiments, the sales and distribution factor group may include factors such as a sale of a product, an order history, and a sales plan. In some embodiments, the inventory factor group may include factors such as an inventory history and an inventory plan. In some embodiments, the one or more client devices 116A-N obtain data relating to an in-store execution activity about the group and communicates the data relating to the in-store execution activity to the probabilistic forecast management server 104. In some embodiments, the probabilistic forecast management server 104 enables the one or more client devices 116A-N associated with the one or more clients 118A-N to select products of interest.

In some embodiments, the probabilistic forecast management server 104 may model existing probabilistic forecast management services to determine an infrastructure of the probabilistic forecast management environment 108 which may be required or preferred. In some embodiments, the probabilistic forecast management server 104 may capture operational constraints of the factor group from the one or more client devices 116A-N associated with the one or more clients 118A-N. In some embodiments, the probabilistic forecast management server 104 may allow the one or more clients 118A-N to request an update in at least one of (i) the specification information of the use-case or (ii) either historical or planned value of the internal data. In some embodiments, the probabilistic forecast management server 104 includes one or more machine learning models. The one or more machine learning models include an anticipation ML model that optimizes the objective factor or a recommendation ML model that generates a recommendation for optimizing at least one factor of a factor group. In some embodiments, the one or more machine learning models may include, but not limited to, advanced algorithms including but not limited to SVR, XGBoost, Random Forests, Prophet, DeepAR, LSTM/RNNs, Generative Adversarial Systems, Convolutional Neural Systems, Quantile Regressions, Bayesian Regressions, Factorization Machines, Bayesian Structural Time Series Models, Hidden Markov Models, and Monte Carlo Markov Chains.

The probabilistic forecast management server 104 trains at least one machine learning model of at least one of a first automated system of machine learning models, a second automated system of machine learning models and a third automated system of machine learning models with processed specification information and the internal data. In some embodiments, machine learning models of the first automated system of machine learning models that includes one or more machine learning models are trained using the historical data of a forecasted factor and the historical data of at least one factor group associated with the use-case. In some embodiments, machine learning models of the second automated system of machine learning models that includes one or more machine learning models is trained using the external information data, the historical data of a forecasted factor, historical data of an objective factor and the historical data of at least one factor group associated with the use-case. In some embodiments, machine learning models of the third automated system of machine learning models that includes one or more machine learning models is trained using the historical data associated with a use-case.

The probabilistic forecast management server 104 optimizes an objective factor of a product of the use-case using the third automated system of machine learning models. In some embodiments, the product of the use-case is at least one of consumer products or industrial products and services. In some embodiments, the consumer products include (i) convenience products, e.g. newspapers, matchbox, soaps, toothpastes etc. In some embodiments, the industrial products and services offer goods and services and include those used in a production of a final product, e.g., basic or raw materials and components, instruments, hardware or tools. In some embodiments, the product is a perishable product.

The probabilistic forecast management server 104 dynamically generates a recommendation to adjust an existing forecast that collectively optimizes the objective factor based on the optimization function using the third automated system of machine learning models. The dynamic recommendation is a recommendation that is associated with at least one factor group and collectively optimizes the objective factor of the use-case associated with the probabilistic forecast management service.

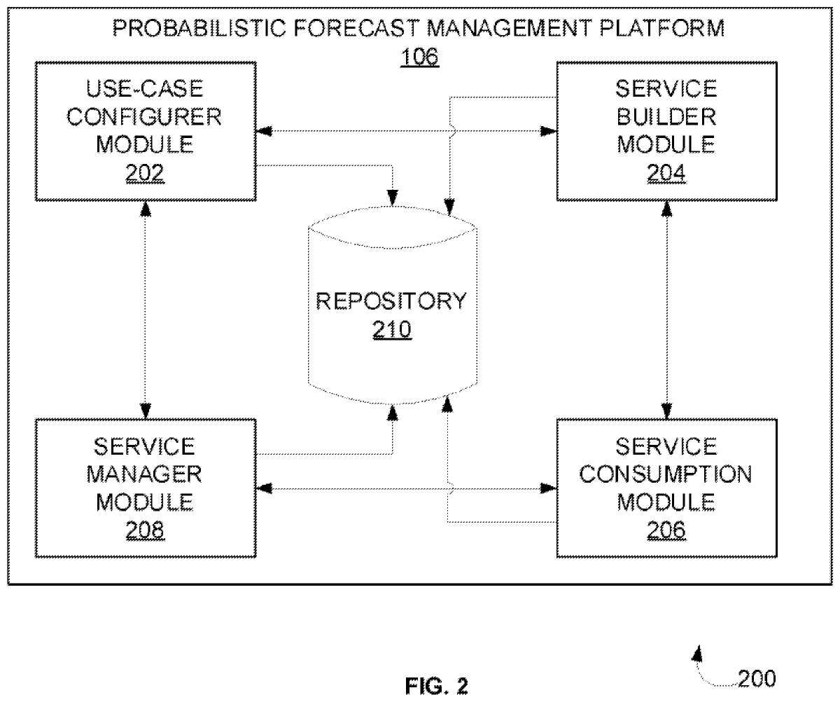

FIG. 2 is a block diagram 200 of the probabilistic forecast management platform of a probabilistic forecast management server 104 of FIG. 1 according to some embodiments herein. The deviation management platform 106 includes the use-case configurer module 202, a service builder module 204, the service consumption module 206, a service manager module 208, and a repository 210. In some embodiments, the service consumption module 206 is connected to the network 114 in order to facilitate the usage of a probabilistic forecast management service to the one or more client devices 116A-N.

The use-case configurer module 202 captures a specification information of a use-case for which the probabilistic forecast management service is created. In some embodiments, the specification information includes internal data of the use-case and the meta-data model that is applicable for the use-case. In some embodiments, the use-case configurer module 202 enables the client device 116 to select factors of interest and models existing probabilistic forecast management services to determine the infrastructure of the probabilistic forecast management environment 108 which may be required or preferred. The use-case configurer module 202 captures one or more possible actions from the client device 116 and operational constraints of the use-case.

The service builder module 204 is configured to receive the specification information of the use-case from the use-case configure module 202. The service builder module 204 may assemble, validate and publish the probabilistic forecast management service to the service consumption module 206 for consumption of the probabilistic forecast management service by the one or more client devices 116A-N associated with the service.

The service consumption module 206 is configured to allow the one or more client devices 116A-N to use the probabilistic forecast management service. In some embodiments, the service consumption module 206 may allow a user to request an update in the specification information of the use-case. The service manager module 208 manages the probabilistic forecast management service by communicating with the probabilistic forecast management environment 108.

The service manager module 208 updates in real-time the recommendation ML models that generate the recommendation for adjusting the existing forecast of at least one forecasted factor of the factor group. The service manager module 208 generates the dynamic recommendation to the client devices 116A-N to update values of the at least one factor of the factor group. The dynamic recommendation is a recommendation that is associated with the factor group and collectively optimizes the objective factor of the probabilistic forecast management service

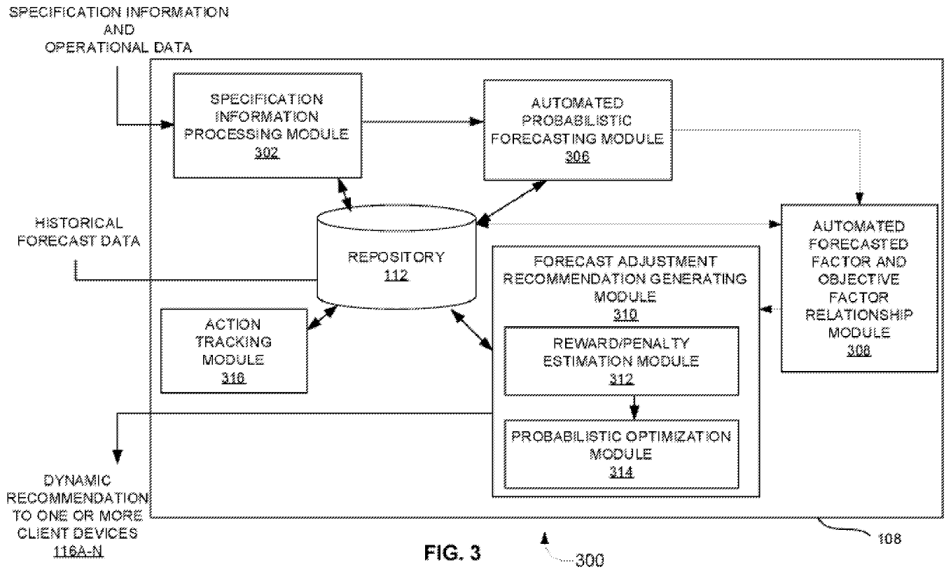

FIG. 3 is a block diagram 300 of the probabilistic forecast management environment of the probabilistic forecast management server 104 of FIG. 1 according to some embodiments herein. The block diagram 300 includes a specification information processing module 302, an automated probabilistic forecasting module 306, an automated forecasted factor and objective factor relationship module 308, a forecast adjustment recommendation generating module 310, a reward or penalty estimation module 312, a probabilistic optimization module 314, a forecast adjustment recommendation generating module 314 and an action tracking module 316. In some embodiments, the specification information processing module 302, the automated probabilistic forecasting module 306, and the forecast adjustment recommendation generating module 310 are interconnected with each other and work on common interconnecting factors and common data available in the repository 210. In some embodiments, the specific information processing module 302, the machine learning model training module, the automated probabilistic forecasting module 306 and the forecast adjustment recommendation generating module 310 generate recommendations to adjust an existing forecast.

In some embodiments, each of the automated probabilistic forecasting module 306, the automated forecasted factor and objective factor relationship module 308 and the forecast adjustment recommendation generating module 310 may include a machine learning model training module that may train one or more machine learning models using the data available in the repository 112.

The specific information processing module 302 receives specification information and internal data of the probabilistic forecast management service from the repository 210 of the probabilistic forecast management platform 106.

The specific information processing module 302 communicates the quantified probabilistic values to the machine learning model training module, the automated probabilistic forecasting module 306, and the forecast adjustment recommendation generating module 310. The specific information processing module 302 utilizes deep learning and machine learning algorithms to identify an emerging signal which may be indicative of an impact with respect to a factor.

In some embodiments, the factor is one or more of incentive actions, events, price-pack, brand attribute, stock keeping unit attribute, weather, channel coverage, sale activities, or geographical attributes, a lead time, an order frequency, a reorder point, a delivery mode, a demand consumption, a system path, a channel contract, a demand volatility, or a production schedule. In some embodiments, the factor is an external factor including weather factors, macro-economic factors, demographic factors, consumer trend factor, or a media factor. In some embodiments, the factor includes an objective factor and a constraint factor. In some embodiments, the constraint factor acts as an operational constraint for the objective factor. For example, the constraint factor on hand Inventory may be a constraint for an objective factor of the fill rate. Another example is the objective factor of service level being impacted by a constraint factor cost. Few examples of the constraint factor are safety stock, lead time for delivery, order quantities, minimum on hand inventory, maximum on hand inventory, service level, production quantity etc. Exemplary factor groups may include inventory, production, logistics, raw materials, etc. In some embodiments, data that relates to the external factors may be stored in the external information database 112 and the data related to the internal data may be stored in the repository 210.

In some embodiments, the specific information processing module 302 constantly updates the one or more machine learning models based on the latest available data from internal data available in the repository 210 and data available in the external information database 112. The specific information processing module 302 is updated with one or more frequencies such as daily, weekly, etc. which results in the update of quantified probabilistic values. In some embodiments, the machine learning model training module, the automated probabilistic forecasting module 306, and the forecast adjustment recommendation generating module 310 are updated with the one or more frequencies. The machine learning model training module, the automated probabilistic forecasting module 306 and the forecast adjustment recommendation generating module 310 are also constantly training one or more machine learning models associated with them based on updates of the specific information processing module 302.

In some embodiments, automated probabilistic forecasting module 306 includes the first automated system of machine learning models that includes one or more machine learning models that are trained by machine learning model training module using data available in the repository 112 that includes the historical data of a forecasted factor and the historical data of at least one factor group associated with the use-case. In some embodiments, the automated forecasted factor and objective factor relationship module 308 includes the second automated system of machine learning models that includes one or more machine learning models that are trained by machine learning model training module using data available in the repository 112 that includes using the external data, the historical data of a forecasted factor, historical data of an objective factor and the historical data of at least one factor group associated with the use-case.

In some embodiments, the forecast adjustment recommendation generating module 310 includes the third automated system of machine learning models that includes one or more machine learning models. In some embodiments, an output of the first automated system of machine learning models is mathematical model of the forecasted factor of the use-case. In some embodiments, an output of the second automated system of machine learning models is a mathematical model of the relationship between the forecasted factor, an objective factor and at least one factor of a factor group. In some embodiments, the forecast adjustment recommendation generating module 310 determines an optimization model using a simulation based optimization, wherein the simulation is run on at least one adjustment of the existing forecast of the forecasted factor based on the probabilistic forecasting model and the relationship model using a third automated system of machine learning models, wherein said at least one adjustment includes an amount of return gained on said adjustment and an amount of risk undertaken in said adjustment.

In some embodiments, the one or more machine learning models of the third automated system of machine learning models are trained by machine learning model training module using the training data and the output of both the first automated system of machine learning models and the second automated system of machine learning models. The third automated system of machine learning models determines an optimization model using a simulation based optimization, wherein the simulation is run on one or more adjustments of the existing forecast of the forecasted factor based on the probabilistic forecasting model and the relationship model, wherein the at least one adjustment includes an amount of return gained on said adjustment and an amount of risk undertaken in said adjustment.

In some embodiments, the third automated system of machine learning models are trained using an agent and an environment. The environment may include a combination of the first automated system of machine learning models and the second automated system of machine learning models. The agent takes an action and measures the output states that are generated from the environment. In some embodiments, the action includes an adjustment of the forecast of a forecasted factor. In some embodiments, adjustment may be done on one or more values of one or more factors associated with a factor group.

In some embodiments, the one or more machine learning models of the third automated system of machine learning models may be trained by machine learning model training module using simulation based optimization techniques that include but not limited to reinforcement learning, multi arm bandit and stochastic optimization.

In some embodiments, the recommendation generated by forecast adjustment recommendation generating module 310 may include price-pack additions or changes, an identification of a deviation for a point of sale or retailer, a recommendation for adjustment to sales activities, or a recommendation for channel incentive allocation or reallocation.

In some embodiments, the one or more machine learning models of the machine learning models of the first automated system of machine learning models, the second automated system of machine learning models and the third automated system of machine learning models may be interconnected with each other in such a manner that an output of the first machine learning model becomes a feature for the second machine learning model.

The automated probabilistic forecasting module 306 receives the quantified probabilistic values from the specific information processing module 302.

The recommendation generated at the forecast adjustment recommendation generating module 314 may include the recommendation to adjust an existing forecast that collectively optimizes the objective factor based on the optimization function using the third automated system of machine learning models. The recommendation generated by the automated probabilistic forecasting module 306 may be the combination of the one or more factors of the pricing and promotions factor group include factors such as a channel, a location of a promotion activity, a product for promotion, a price-pack, a time period (calendar) for a promotion activity, a promotion type, a price for a promotion activity, a discount for a promotion activity or a creative for a promotion activity. In some embodiments, the recommendation generated by the automated probabilistic forecasting module 306 may include the recommendation for promotion budget reallocations, a recommendation for promotion event adjustments, or a recommendation for promotion forecasts and lift prediction for a plan of promotion.

The action tracking module 316 may track one or more adjustments made in the use-case based on the recommendation to enable feedback based learning of at least one machine learning model of at least one of the first automated system of machine learning model s, the second automated system of machine learning models and the second automated system of machine learning models to provide an improved recommendation.

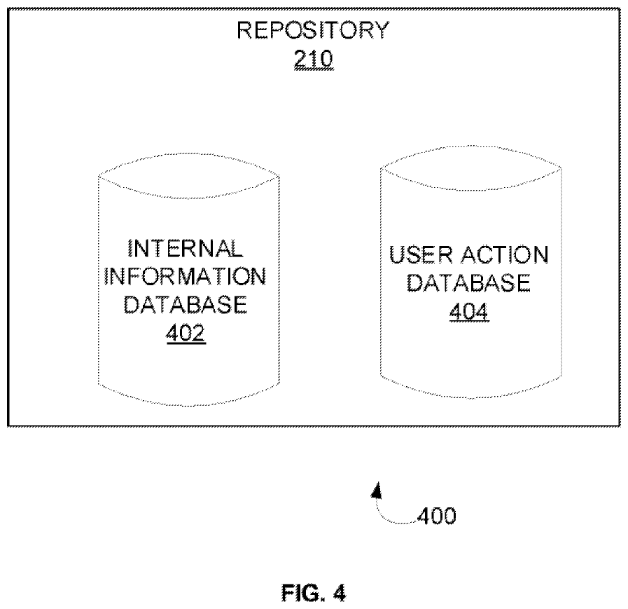

FIG. 4 is a block diagram 400 of the repository 210 of the probabilistic forecast management platform 106 of FIG. 2 according to some embodiments herein. The block diagram 400 of the repository 210 includes an internal information database 402 and a user action database 404. The internal information database 402 includes historical data associated with a use-case, wherein the historical data includes historical data of a forecasted factor, historical data of an objective factor and historical data of at least one factor group associated with the use-case. In some embodiments, the internal information database 402 includes data that is internal related to internal factors of a use-case. The user action database 404 stores actions which are taken by the one or more clients 116A-N in the group.

In some embodiments, the internal information database 402 may include internal data. The internal data of the group may include sales operations.

In some embodiments, the internal information database 402 includes planning data of the group. The planning data of the group may include sales plans and forecasts, financial plans and forecasts, price plans, marketing plans, promotion plans, demand plans, inventory plans, production plans.

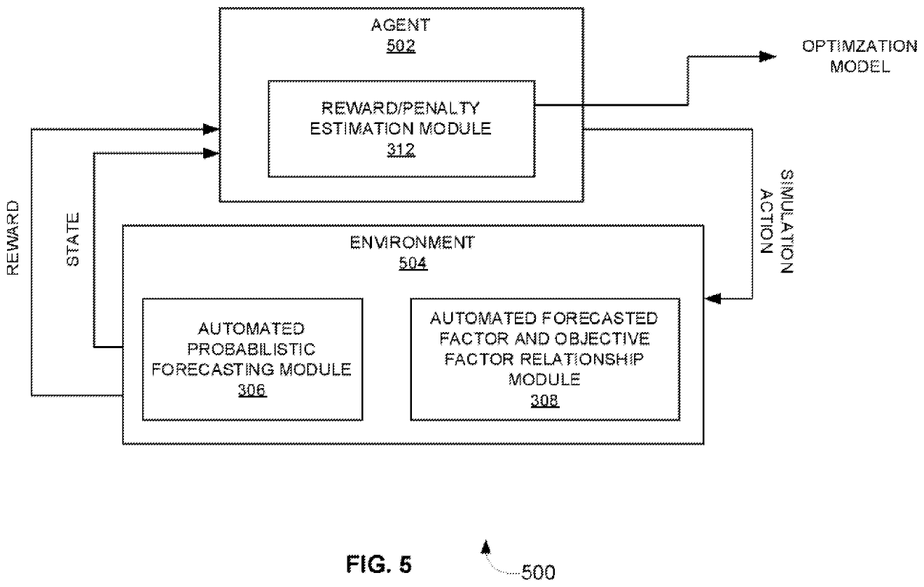

FIG. 5 is a block diagram 500 of simulation based learning to obtain an optimization model, according to some embodiments herein. The block diagram 500 includes an agent 502, an environment 504, the reward/penalty estimation module 312, the automated probabilistic forecasting module 306 and automated forecasted factor and objective factor relationship module 308. In some embodiments, an optimization model is determined using the simulation based optimization as described in the block diagram 500, where the simulation is run on one or more adjustments of the existing forecast of the forecasted factor based on the probabilistic forecasting model and the relationship model using a third automated system of machine learning models, where said one or more adjustment include an amount of return gained on said adjustment and an amount of risk undertaken in said adjustment.

In some embodiments, the agent 502 facilitates the reward/penalty estimation module 312 to take one or more simulation actions. The one or more simulation actions may include one or more adjustments to an existing forecast. The one or more simulation actions is taken on the environment 504 which induces a state which is recorded by the agent 502 in the reward/penalty estimation module 312. The one or more simulation actions may cause either an amount of return gained because of the adjustment or an amount of risk penalty. In some embodiments, the agent 502 determines the optimization model for different states of the environment 504 by transitioning from one state to another and taking the simulation action in a specific state that causes a reward. The agent 502 takes the one or more simulation actions on the environment until the reward is maximized. In some embodiments, the simulation based optimization may utilize a model-free reinforcement learning method to determine the optimization model.

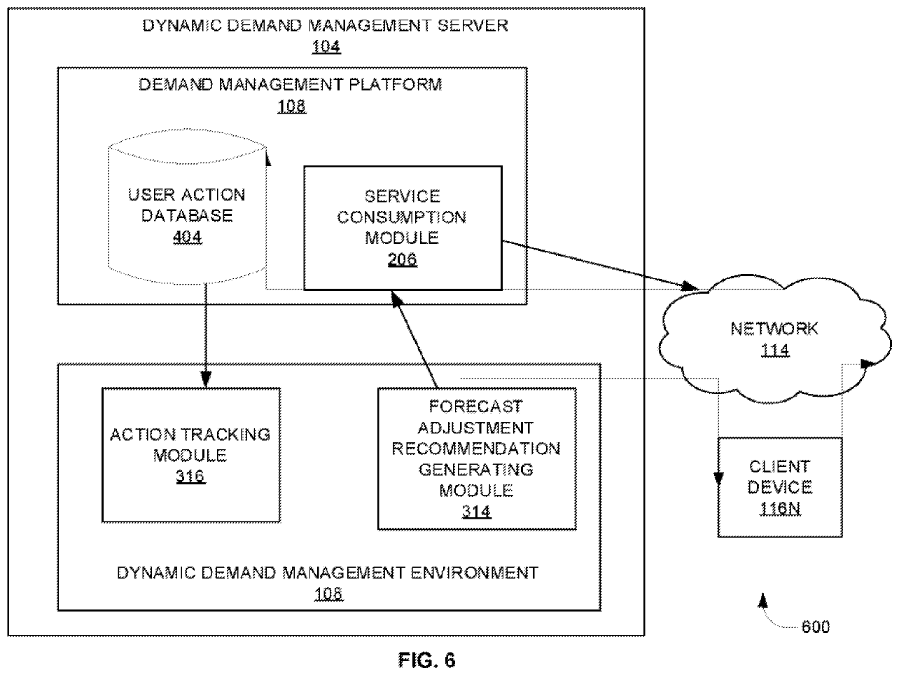

FIG. 6 is a block diagram 600 of a feedback loop that enables feedback based learning of at least one machine learning model to provide an improved recommendation according to some embodiments herein. The action tracking module 316 tracks an action taken by the one or more clients in the group. In some embodiments, the action may be captured from the one or more client devices 116A-N through the network 114. The user action database 404 stores an action taken by the one or more clients in the group. In some embodiments, recorded action taken in the group which is stored in the user action database 404 is transmitted to the action tracking module 316 for enabling reinforcement learning of the machine learning models in the probabilistic forecast management environment 108. The action tracking module 316 may employ advanced machine learning models for providing accurate predictions on the demand of the product.

In some embodiments, the machine learning model training module, the automated probabilistic forecasting module 306, and automated forecasted factor and objective factor relationship module 308 generate recommendations and communicate the recommendations to the client device 116A through the network 114. The probabilistic forecast management server 104 communicates the accurate predictions and improved action recommendations to the one or more client devices 116A-N through the network 114.

| Adjusted Demand | Fill Rate | On-Hand Inventory |
|---|---|---|
| Forecasted Factor | Objective Factor | Constraint Factor |
| 409 | 76% | 300 |
| 403 | 87% | 350 |
| 403 | 91% | 370 |
| 425 | 92% | 390 |
| 414 | 94% | 380 |
| 425 | 76% | 320 |
| 419 | 82% | 330 |
| 409 | 80% | 310 |

The table here illustrates an example of the adjusted values of the demand forecasted factor taking into account the objective factor fill rate and the constraint factor on hand inventory constraint determined by the forecast adjustment recommendation generating module 310 for the use-case to collectively optimize the objective factor fill rate.

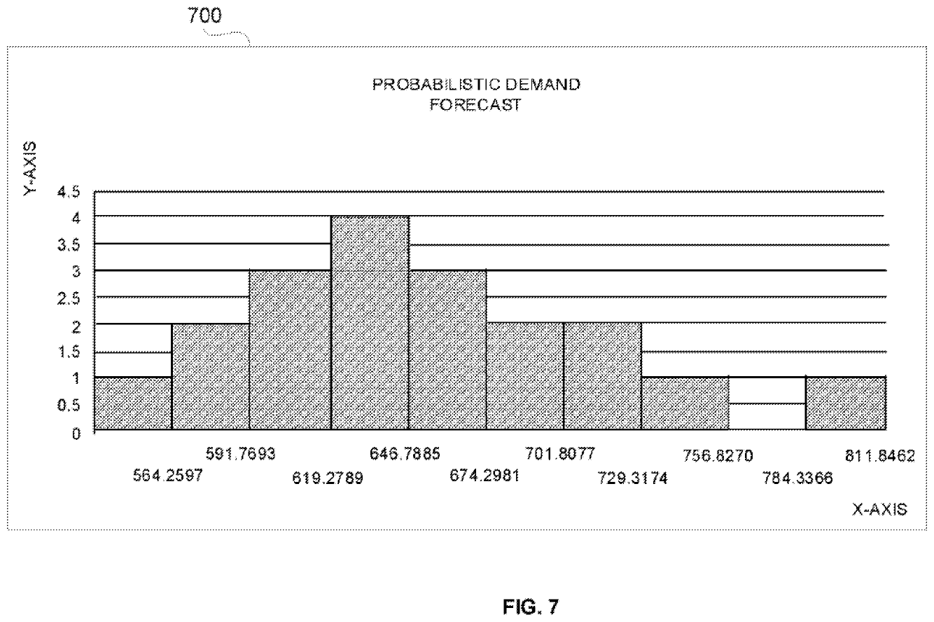

FIG. 7 is an exemplary graphical representation 700 of probabilistic demand forecasted factor generated using the first automated system of machine learning models, according to an embodiment herein. In an exemplary embodiment, the probabilistic demand forecasted factor is the process in which historical sales or shipment or order data is used to develop an estimate of an expected forecast of customer demand for different values of one of more factor groups. To a use-case, the probabilistic demand forecasted factor provides an estimate of the amount of goods and services that the customers of the use-case will purchase in the foreseeable future, for example. As illustrated herein, the Y-axis is plotted with the probability values and the demand forecasted factor values is plotted on X-axis.

| Cumulative | Probabilistic Demand |
|---|---|
| Probability | Forecast |
| 5% | 564 |
| 10% | 585 |
| 15% | 600 |
| 20% | 611 |
| 25% | 622 |
| 30% | 631 |
| 35% | 640 |
| 40% | 649 |
| 45% | 657 |
| 50% | 665 |
| 55% | 674 |
| 60% | 682 |
| 65% | 691 |
| 70% | 701 |
| 75% | 712 |
| 80% | 724 |
| 85% | 738 |
| 90% | 756 |
| 95% | 784 |
| 99% | 839 |

In some embodiments, the table above is an output of the probabilistic forecasting module 306 and is generated using the first automated system of machine learning models. The relationship between the demand forecasted factor and fill rate objective factor for different values of on-hand inventory constraint factor is determined using automated forecasted factor and objective factor relationship module 308. An exemplary input data to the automated forecasted factor and objective factor relationship module 308 is illustrated in the table below.

| Demand | Fill Rate | On-Hand Inventory |
|---|---|---|
| Forecasted Factor | Objective Factor | Constraint Factor |
| 572 | 53% | 300 |
| 589 | 60% | 350 |
| 607 | 62% | 370 |
| 606 | 64% | 390 |
| 619 | 63% | 390 |
| 639 | 60% | 380 |
| 644 | 59% | 380 |
| 649 | 59% | 380 |
| 661 | 56% | 370 |
| 668 | 54% | 360 |
| 672 | 52% | 350 |
| 690 | 50% | 340 |
| 686 | 48% | 330 |
| 705 | 46% | 320 |
| 706 | 44% | 310 |
| 717 | 41% | 300 |
| 739 | 39% | 290 |
| 753 | 37% | 280 |
| 780 | 34% | 270 |
| 849 | 31% | 260 |

In some embodiments, the automated forecasted factor and objective factor relationship module 308 may take the table above as an input to determines the relationship between the forecasted factor, a model of an objective factor and one or more factors using the second automated system of machine learning models.

In an embodiment, the fill rate objective factor versus forecasted factor at different values of on hand inventory constraint factor can be plotted on a graph. If the forecasted factor increases on X-axis, the fill rate will increase to a certain factor, beyond which it may not be possible to increase fill rate significantly, giving the graph sigmoid curve, for different values of on hand inventory constraint factor. The reward or penalty estimation module 312 helps determine the most rewarding forecast value for a forecasted factor, to generate most optimised value for a particular objective factor, taking into account a one or more constraint factors. The automated forecasted factor and objective factor relationship module 308 determines the relationship between the forecasted factor, a model of an objective factor and one or more factors using the second automated system of machine learning models. The forecast adjustment recommendation generating module 310 determines the recommended adjustment to the existing forecast of the forecasted factor as an optimization function from the probabilistic optimization module 314 based on the inputs from the automated probabilistic forecasting module 306, automated forecasted factor and objective factor relationship module 308 and reward/penalty estimation module 312. In some embodiments, the relationship between the forecasted factor, a model of an objective factor and one or more factors can be learned or provided to the probabilistic forecast management platform 106.

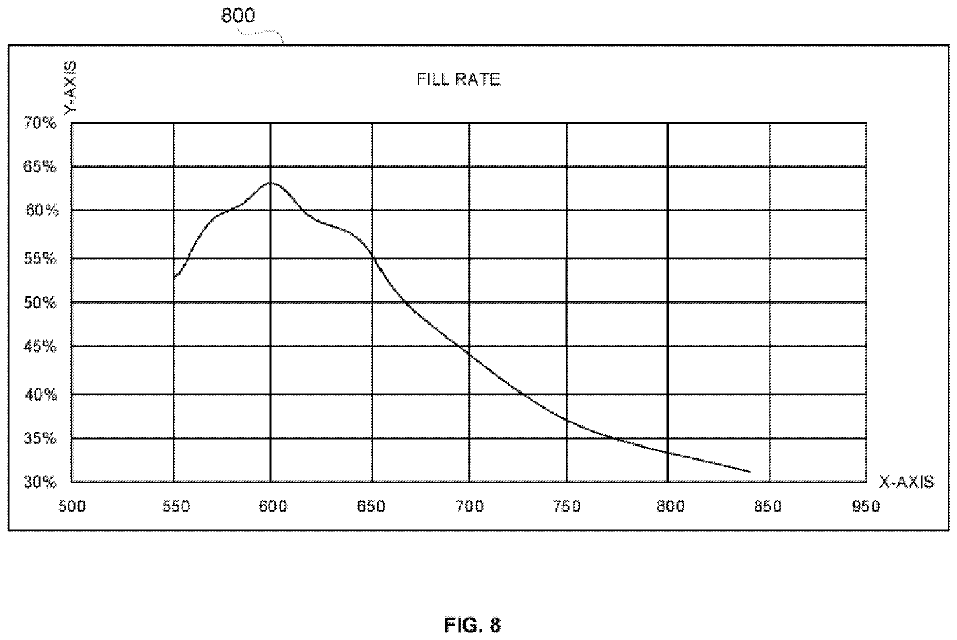

FIG. 8 is a graphical representation 800 that provides an exemplary illustration of an intermediate result of the functioning of the probabilistic optimization module 314 of the forecast adjustment recommendation generating module 310, according to an embodiment herein. The probabilistic optimization module 314 may receive one or more inputs from the reward/penalty estimation module 312, the automated probabilistic forecasting module 306 and the automated forecasted factor and objective factor relationship module. The graph shows the adjusted demand forecasted factor plotted along the X-axis versus the fill rate objective factor on the Y-axis. The existing forecasted factor is forecasted as 550. When the fill rate objective factor is determined for the use-case, the forecast for the maximum fill rate is calculated to be 600 by calculating an adjustment recommendation based on the optimization function to maximize the fill rate objective factor. The adjustment recommendation is determined to be 61 in this exemplary use-case to maximize the objective factor fill rate to optimize it. The forecasted factor values are changed accordingly for a range of probability with the given constraint factor. The adjusted demand forecasted factor, the optimized value of the fill rate objective factor and the on hand inventory constraint factor is used to generate adjusted recommendation at instant time.

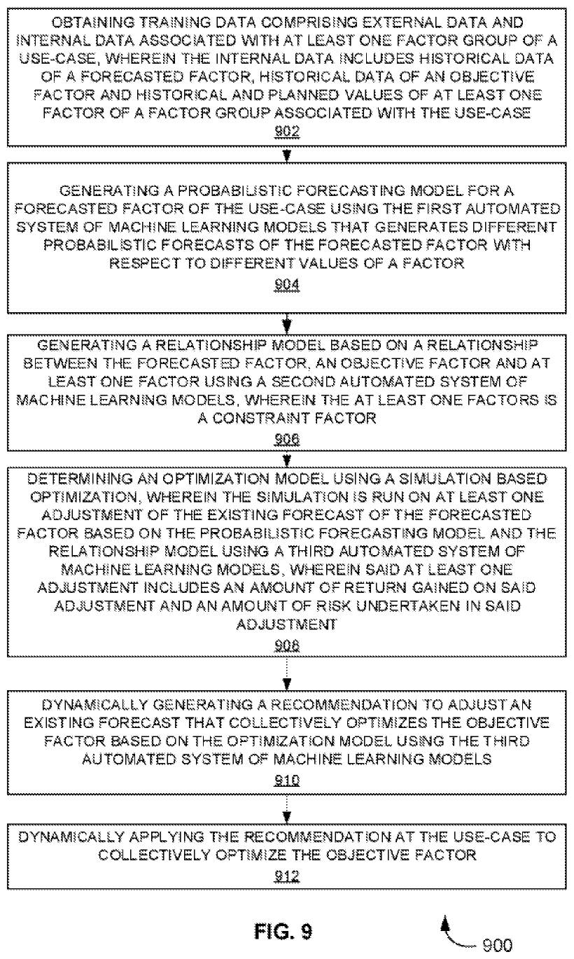

FIG. 9 is a flow diagram that illustrates a method 900 of dynamically recommending forecast adjustments that collectively optimize an objective factor using automated ML systems according to some embodiments herein. At step 902, obtaining training data comprising external data and internal data associated with at least one factor group of a use-case, wherein the internal data includes historical data of a forecasted factor, historical data of an objective factor and historical and planned values of at least one factor of a factor group associated with the use-case. At step 904, generating a probabilistic forecasting model for a forecasted factor of the use-case using the first automated system of machine learning models that generates different probabilistic forecasts of the forecasted factor with respect to different values of a factor. At step 906, generating a relationship model based on a relationship between the forecasted factor, an objective factor and at least one factor using a second automated system of machine learning models, wherein the at least one factors is a constraint factor. At step 908, determining an optimization model using a simulation based optimization, wherein the simulation is run on at least one adjustment of the existing forecast of the forecasted factor based on the probabilistic forecasting model and the relationship model using a third automated system of machine learning models, wherein said at least one adjustment includes an amount of return gained on said adjustment and an amount of risk undertaken in said adjustment. At step 910, dynamically generating a recommendation to adjust an existing forecast that collectively optimizes the objective factor based on the optimization model using the third automated system of machine learning models. At step 912, dynamically applying the recommendation at the use-case to collectively optimize the objective factor.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. System adapters may also be coupled to the system to enable the data processing system to become coupled to other data processing systems or remote printers or storage devices through intervening private or public systems. Modems, cable modem and Ethernet cards are just a few of the currently available types of system adapters.

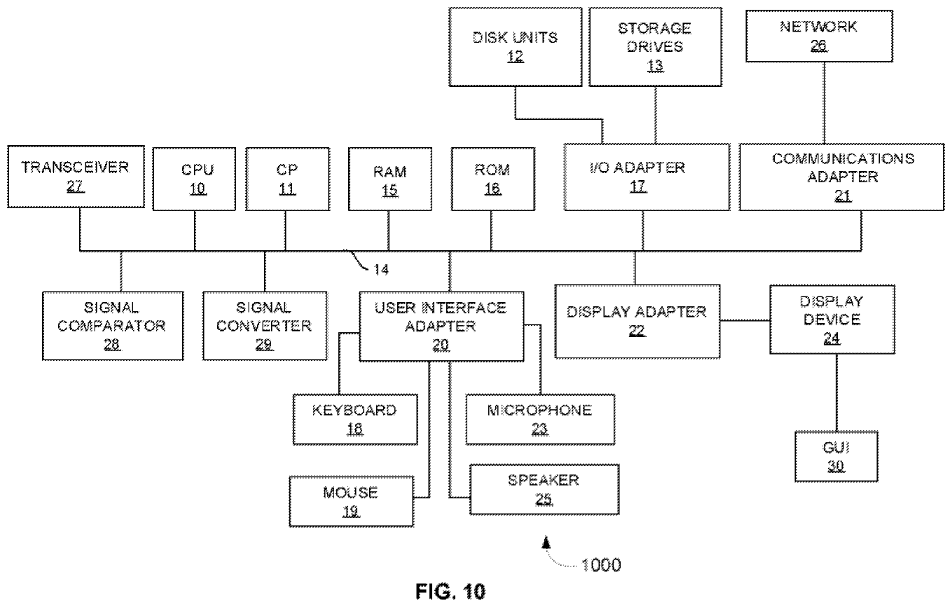

A representative hardware environment 1000 for practicing the embodiments herein is depicted in FIG. 10, with reference to FIGS. 1 through 9. This schematic drawing illustrates a hardware configuration of a server/computer system/user device in accordance with the embodiments herein. The user device includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The VO adapter 17 can connect to peripheral devices, such as disk units 12 and tape drives 13, or other program storage devices that are readable by the system. The user device can read the inventive instructions on the program storage devices and follow these instructions to execute the methodology of the embodiments herein. The user device further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing system 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The major advantages of the method and system for dynamically generating recommendations to adjust an existing forecast that collectively optimizes an objective factor using an automated system of machine learning models are, increased scale and ability to handle the thousands of factors and tera and peta bytes of data for enterprises. The human bias is quantified in systematic way to automate forecasting of a factor or a factor group to optimize an objective factor for a use case. The method applies advance machine learning modules which are trained on large volume of data that is not possible with traditional computational methods. Complex engineering and automated form of computer workflow is utilized using distributed CPU, GPU processing, heavy data ingestion and ETL/ELT pipelines and algorithm training and prediction pipelines are utilized to be able to forecast accurately and dynamically taking into account multiple co-related factors throughout the entire chain of demand side, supply side, sales, inventory, human factors etc. across large multi county operations.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A method for dynamically generating recommendations to adjust an existing forecast to collectively optimize an objective factor using an automated system of machine learning models, the method comprising:
obtaining training data comprising external data and internal data associated with at least one factor group of a use-case, wherein the internal data includes historical data of a forecasted factor, historical data of an objective factor and historical and planned values of at least one factor of a factor group associated with the use-case;
generating a probabilistic forecasting model for a forecasted factor of the use-case using the first automated system of machine learning models that generates different probabilistic forecasts of the forecasted factor with respect to different values of a factor;
generating a relationship model based on a relationship between the forecasted factor, an objective factor and at least one factor using a second automated system of machine learning models, wherein the at least one factors is a constraint factor;
determining an optimization model using a simulation based optimization, wherein the simulation is run on at least one adjustment of the existing forecast of the forecasted factor based on the probabilistic forecasting model and the relationship model using a third automated system of machine learning models, wherein said at least one adjustment includes an amount of return gained on said adjustment and an amount of risk undertaken in said adjustment;
dynamically generating a recommendation to adjust an existing forecast that collectively optimizes the objective factor based on the optimization model using the third automated system of machine learning models; and
dynamically applying the recommendation at the use-case to collectively optimize the objective factor.

2. The method as claimed in claim 1, wherein the method further comprises automatically causing a comparison of the probabilistic forecast with an existing forecast of the forecasted factor, wherein the existing forecast of the forecasted factor is generated by at least one of an automated system and a cognitive system.

3. The method as claimed in claim 1, wherein the method further comprises:
training at a server the first automated system of machine learning models that includes one or more machine learning models using the historical data of a forecasted factor and the historical and planned values of at least one factor of a factor group associated with the use-case;
training at a server the second automated system of machine learning models that includes one or more machine learning models using the external data, the historical data of a forecasted factor, historical data of an objective factor and the historical and planned values of at least one factor of a factor group associated with the use-case; and
training at a server the third automated system of machine learning models that includes one or more machine learning models using the training data and output of both the first automated system of machine learning models and the second automated system of machine learning models.

4. The method as claimed in claim 3, wherein the method further comprises using at least one machine learning model to estimate the optimization function.

5. The method as claimed in claim 1, wherein generating the probabilistic forecast for the forecasted factor of the use-case further comprises:
determining a probability distribution of at least one forecast values of the forecasted factor associated with a set, wherein the set includes a product and a distribution location of the product;
automatically selecting a prediction interval of the forecast for at least one probability level; and
determining a probability of the probability distribution falling in the prediction interval to obtain the probabilistic forecast.

6. The method as claimed in claim 1, wherein the objective factor includes a service level, and an out of stock and the objective factor is associated with at least one constraint that includes a cost, and an inventory.

7. The method as claimed in claim 1, wherein at least one machine learning model of the first and second automated system of machine learning models utilize at least one of machine learning, deep learning, probabilistic machine learning and statistical deep learning methods.

8. The method as claimed in claim 1, wherein at least one machine learning model of the third automated system of machine learning models utilizes stochastic optimization and/or reinforcement learning.

9. The method as claimed in claim 1, wherein the method further comprises tracking at least one adjustment made in the use-case based on the recommendation to enable feedback based learning of at least one machine learning model of at least one of the first automated system of machine learning models, the second automated system of machine learning models and the third automated system of machine learning models to provide an improved recommendation.

10. A system of dynamically generating recommendations to adjust an existing forecast that collectively optimizes an objective factor using an automated system of machine learning models, the system comprising:
a probabilistic forecast management server that comprises:
a memory that stores a set of instructions; and
a processor that executes the set of instructions and is configured to:
obtaining training data comprising external data and internal data associated with at least one factor group of a use-case, wherein the internal data includes historical data of a forecasted factor, historical data of an objective factor and historical and planned values of at least one factor of a factor group associated with the use-case;
generating a probabilistic forecasting model for a forecasted factor of the use-case using the first automated system of machine learning models that generates different probabilistic forecasts of the forecasted factor with respect to different values of a factor;
generating a relationship model based on a relationship between the forecasted factor, an objective factor and at least one factor using a second automated system of machine learning models, wherein the at least one factors is a constraint factor;
determining an optimization model using a simulation based optimization, wherein the simulation is run on at least one adjustment of the existing forecast of the forecasted factor based on the probabilistic forecasting model and the relationship model using a third automated system of machine learning models, wherein said at least one adjustment includes an amount of return gained on said adjustment and an amount of risk undertaken in said adjustment;
dynamically generating a recommendation to adjust an existing forecast that collectively optimizes the objective factor based on the optimization model using the third automated system of machine learning models; and
dynamically applying the recommendation at the use-case to collectively optimize the objective factor.
